(19) United States
(12) Patent Application Publication
(10) Pub. No.: US 2026/0308406 A1
(43) Pub. Date: Oct. 8, 2026

(54) UV-CURABLE INK COMPOSITION, AND INTERIOR FILM COMPRISING INK LAYER FORMED THEREFROM

(71) Applicant: KCC GLASS Corporation, Seoul (KR)

(72) Inventors: Jeong-Hee LEE, Seoul (KR); Jangwook KIM, Yongin-si, Gyeonggi-do (KR); Sung-Ha SEO, Gunpo-si, Gyeonggi-do (KR); Byung-Young JUNG, Yongin-si, Gyeonggi-do (KR)

(21) Appl. No.: 19/483,245

(22) PCT Filed: Apr. 30, 2024
(86) PCT No.: PCT/KR2024/005889

§ 371 Date: Nov. 11, 2025

(30) Foreign Application Priority Data
Jun. 15, 2023 (KR) 10-2023-0077001

(51) Int. Cl. C09D 11/38

(52) U.S. Cl. CPC C09D 11/38

(57) ABSTRACT

The present invention relates to a UV-curable ink composition, and an interior film comprising same, the ink composition comprising a pigment, a urethane (meth) acrylate oligomer, a (meth) acrylate monomer, a caprolactam-based compound, and an UV initiator, wherein the urethane (meth) acrylate oligomer comprises two functional groups and has a weight average molecular weight of 500 to 2,000 g/mol.

### TECHNICAL FIELD

This application claims priority from Korean Patent Application No. 10-2023-0077001, filed on Jun. 15, 2023, in the Korean Intellectual Property Office, the disclosures of which are incorporated herein in its entirety by reference.

The present invention relates to an ultraviolet-curable ink composition having excellent storage stability at room temperature and high temperatures, and having excellent design freedom and printability during printing using a digital printer, and an interior film including an ink layer formed therefrom.

### BACKGROUND ART

As a method for applying a specific color to various types of substrates or forming patterns, various printing methods such as flexo printing, gravure printing, inkjet printing, and screen printing have been used. Particularly, gravure printing and flexo printing have been widely used since they allow for mass production at high speeds. However, there have been limitations in that gravure printing and flexo printing incur additional costs and time for manufacturing of copper plates, etc., for a design change, and the resolution of images after printing is not sufficient. In addition, in a typical printing method, a solvent-type ink including an organic solvent is commonly used, and the solvent-type ink includes the organic solvent in the ink, and thus, releases a large amount of a volatile organic compound (VOC), thereby causing an environmental problem.

As an alternative to the above, digital printer printing and the use of ultraviolet-curable inks have been proposed. For example, Japanese Patent Registration No. 5631588 (Patent Document 1) discloses an ink for inkjet printing, which includes at least one irradiation-curable monomer, at least one inert thermoplastic resin, at least one radical photoinitiator, and at least one coloring agent. However, unlike an ink for gravure printing, an ink for a digital printer has a deviation in performance of the ink itself due to the selection and low viscosity of a raw material printable with a digital printer, conditions of nano-sized particles, and the like, and has a limitation in matching a manufacturing concept of a printed product.

Therefore, there is a need for the research and development on a ultraviolet-curable ink composition, which is printable with a digital printer, has excellent storage stability at room temperature and high temperatures, and has excellent design freedom and printability during printing using a digital printer, and on an interior film including a layer derived from the composition.

### DISCLOSURE OF THE INVENTION

### Technical Problem

The present invention is to provide a ultraviolet-curable ink composition, which is printable with a digital printer, has excellent storage stability at room temperature and high temperatures, and has excellent design freedom and printability during printing using a digital printer, and an interior film including an ink layer formed therefrom.

### Technical Solution

The present invention provides an ultraviolet-curable ink composition including a pigment, a urethane(meth)acrylate oligomer, a (meth)acrylate monomer, a caprolactam-based compound, and an ultraviolet initiator,
wherein the urethane(meth)acrylate oligomer includes two functional groups, and has a weight average molecular weight of 500 g/mol to 2,000 g/mol.

In addition, the present invention provides an interior film including a base layer;
an ink layer formed on the base layer, and formed from the ultraviolet-curable ink composition;
an adhesive layer formed on the ink layer; and
a transparent protective layer formed on the adhesive layer.

### Advantageous Effects

An ultraviolet-curable ink composition according to the present invention has excellent storage stability at room temperature (25° C.) and a high temperature (60° C.), has excellent image resolution after printing, and has excellent design freedom and printability during printing.

In addition, an interior film according to the present invention, which includes an ink layer formed from the ultraviolet-curable ink composition, has excellent image resolution, thereby having excellent appearance properties, and has excellent interlayer adhesion, thereby having reduced defects such as interlayer peeling, so that the physical properties and productivity of a product are excellent.

### BEST MODE FOR CARRYING OUT THE INVENTION

Hereinafter, the present invention will be described in detail.

In the specification, when a portion is said to “include” any component, it means that the portion may further include another component rather than excluding the another component unless otherwise stated.

In addition, in the present specification, when a layer is said to be positioned “on” another layer, it includes not only a case in which the layer is in contact with the another layer, but also a case in which yet another layer is present between the two layers.

Furthermore, in the present specification, a “weight average molecular weight” is measured by a typical method known in the art, and may be measured by, for example, a gel permeation chromatograph (GPC) method and the like.

A “viscosity” is measured by a typical method known in the art, and may be measured by, for example, using a Brookfield viscometer (rotational spindle viscometer) at room temperature (25° C.).

A “particle size,” which is the diameter of a particle, is measured by a typical method known in the art, and may be measured by, for example, laser light scattering (LLS), and an “average particle size” may be an average value of particle diameters of 10% (D₁₀) to 90% (D₉₀) of cumulative distribution in the distribution of particle sizes as measured as described above.

In addition, a “functional group” is a functional group involved in a polymerization reaction, and may be, for example, a (meth)acrylate group, and “(meth)acrylate” means “acrylate” and/or “methacrylate.”

### Ultraviolet-Curable Ink Composition

An ultraviolet-curable ink composition according to the present invention includes a pigment, a urethane(meth)acrylate oligomer, a (meth)acrylate monomer, a caprolactam-based compound, and an ultraviolet initiator.

Specifically, the ink composition of the present invention includes a urethane(meth)acrylate oligomer and a (meth)acrylate monomer, so that the ink composition has a suitable viscosity, and thus is applicable to a digital printing method, and the ink composition has excellent storage stability, so that there is an effect in that an ink layer prepared therefrom has excellent peel strength.

If the ink composition includes only a urethane(meth)acrylate oligomer, and does not include a (meth)acrylate monomer, the ink composition has high viscosity at 25° C., so that it is difficult to apply the ink composition to a digital printer, and there is a problem in that a digital printer head does not provide an output. On the other hand, if the ink composition includes only a (meth)acrylate monomer, and does not include a urethane(meth)acrylate oligomer, the ink composition has low viscosity, so that there is a problem in that a digital printer head does not provide an output, and even if the ink composition is composed only of a monomer having high viscosity, thereby enabling the output, there is a problem in that adhesion and durability are insufficient, which may cause a problem in that a printed material is damaged as the printed material does not maintain an initial state over time. In addition, if the ink composition includes only a (meth)acrylate monomer, and does not include a urethane(meth)acrylate oligomer, there may be a problem in that it is difficult to produce a product due to insufficient implementation of physical properties. Therefore, the ink composition of the present invention includes a urethane(meth)acrylate oligomer and a (meth)acrylate monomer in combination, thereby preventing the above-described problems, and obtaining the above-described effect.

### Pigment

A pigment serves to impart a color to the ink composition. In this case, the pigment may be, for example, a coloring pigment.

The coloring pigment serves to impart a color to a coating film to form an image. In this case, the coloring pigment may be a black pigment, a white pigment, a blue pigment, a cyan pigment, a red pigment, a magenta pigment, a yellow pigment, a violet pigment, or a mixture thereof. In this case, the coloring pigment may be used without particular limitation as long as it is typically applicable to an ink.

The pigment may be in the form of a pigment dispersion, and for example, the pigment dispersed in the dispersion may have an average particle size of 50 nm to 200 nm, 60 nm to 160 nm, or 80 nm to 140 nm. If the average particle size of the pigment in the dispersion is within the above-described range, the ink composition has excellent storage stability. In addition, if the average particle size of the pigment in the pigment dispersion is less than the above-described range, an ink including the same has degraded shielding force, thereby lowering color density, so that there is a limitation in color implementation, and in addition, due to a very small particle size of the pigment, the force by which pigment particles agglomerate again becomes strong, resulting in degrading storage stability of the dispersion, so that gelation may easily occur. Meanwhile, if the average particle size of the pigment in the pigment dispersion is greater than the above-described range, there may be a problem that a head nozzle is clogged when discharging an ink including the same.

In addition, the pigment dispersion may have a viscosity at 25° C. of 20 cps to 50 cps, 20 cps to 40 cps, or 25 cps to 35 cps. If the viscosity at 25° C. of the pigment dispersion is less than the above-described range, there is a problem with the stability of the pigment dispersion, resulting in increasing viscosity over time, thereby causing gelation, and if greater than the above-described range, the viscosity of an ink including the same increases, which may degrade output stability of the ink.

The ultraviolet-curable ink composition may include 13 wt % to 24 wt %, or 15 wt % to 21 wt % of the pigment based on the total weight of the ink composition. If the content of the pigment is less than the above-described range, a printed material may have reduced color development, and if greater than the above-described range, the content of an ink, which is a solid in the composition, is high, which may deteriorate ink discharge properties.

### Urethane(Meth)Acrylate Oligomer

A urethane(meth)acrylate oligomer is a main raw material governing the physical properties of an ink composition, and serves to adjust the discharge properties and storage stability of an ink, and the peel strength of an ink layer prepared therefrom, and the like. Specifically, the urethane(meth) acrylate oligomer includes a urethane structure having a soft polymer property, thereby improving melting and adhesive properties of the ink composition, and thus has improved adhesion to the base layer, and has an effect of improving the flexibility and elongation of a product such as a manufactured interior film.

The urethane(meth)acrylate oligomer includes two functional groups. If the urethane(meth)acrylate oligomer includes two functional groups, the flexibility of a printed coating surface, and the adhesion thereof to a PVC base material are excellent, so that there is an effect in that the interior film may be commercialized. On the other hand, if one functional group, which is fewer than 2, is included, or no functional group is included, the ink composition may lack curability, which may result in an uncured ink and degraded adhesion. In addition, if three or more functional groups are included, which is greater than the above-described range, a printed material has increased hardness, and thus becomes brittle, which may generate cracks.

In addition, the urethane(meth)acrylate oligomer has a weight average molecular weight (Mw) of 500 g/mol to 2,000 g/mol. If the weight average molecular weight of the urethane(meth)acrylate oligomer is in the above-described range, it is possible to suitably adjust the amount of an oligomer used, so that there is an effect in that adhesion, which is a functional characteristic of a printed coating surface, improves.

Specifically, the urethane(meth)acrylate oligomer may have a weight average molecular weight of 700 g/mol to 1,700 g/mol, or 800 g/mol to 1,500 g/mol. If the weight average molecular weight of the urethane(meth)acrylate oligomer is less than the above-described range, there is a limitation in imparting functionality to the oligomer itself, and as the number of functional groups decreases, the curing performance of the oligomer also decreases, thereby increasing the probability of uncuring, and if greater than the above-described range, ink fluidity is reduced, thereby causing a problem in that a digital printing head is unable to perform discharge, which may lead to a problem with output stability.

The urethane(meth)acrylate oligomer may have a viscosity at 25° C. of 1,000 cps to 5,000 cps, 2,000 cps to 4,800 cps, or 3,000 cps to 4,500 cps. If the viscosity at 25° C. of the urethane(meth)acrylate oligomer is less than the above-described range, the adhesion of a prepared ink layer may be degraded, and if greater than the above-described range, the viscosity of the ink composition increases, resulting in insufficient head discharge properties, so that output stability may be degraded.

In addition, the urethane(meth)acrylate oligomer may be included in an amount of 3 wt % to 15 wt %, or 5 wt % to 10 wt % based on the total weight of the ink composition. If the content of the urethane(meth)acrylate oligomer is less than the above-described range, physical properties of a prepared ink layer may not be suitably secured due to insufficient active ingredients in the ink composition, and if greater than the above-described range, output stability of an inkjet head may be degraded during printing.

### (Meth)Acrylate Monomer

A (meth)acrylate monomer serves to adjust the viscosity of an ink composition to improve ink output properties, and to improve the adhesive strength of an ink layer when forming the ink layer.

The (meth)acrylate monomer may include a bifunctional first (meth)acrylate monomer, and a monofunctional second (meth)acrylate monomer. Specifically, the (meth)acrylate monomer may include a bifunctional first (meth)acrylate monomer containing an aliphatic group, a monofunctional second-1 (meth)acrylate monomer containing an aliphatic group, and a monofunctional second-2 (meth)acrylate monomer containing an aromatic group.

The first (meth)acrylate monomer serves to improve adhesion to a base layer such as PVC. For example, the first (meth)acrylate monomer may be 1,6-hexanediol diacrylate (HDDA).

The second-1 (meth)acrylate monomer serves to impart adhesion to an adhesive layer when manufacturing an interior film. For example, the second-1 (meth)acrylate monomer may be tetrahydrofurfuryl acrylate (THFA).

The second-2 (meth)acrylate monomer serves to suitably adjust the viscosity of the ink composition and to improve the solubility of an ultraviolet initiator. For example, the second-2 (meth)acrylate monomer may be phenoxyethyl acrylate (PHEA).

The (meth)acrylate monomer may have a weight average molecular weight of 100 g/mol to 1,000 g/mol, 100 g/mol to 700 g/mol, or 100 g/mol to 500 g/mol. If the weight average molecular weight of the (meth)acrylate monomer is less than the above-described range, the ink composition has insufficient viscosity, which may cause a problem with an output at a printer head during the output, and if greater than the above-described range, the ink composition has increased viscosity, which may cause a problem with an output at a printer head during the output.

In addition, the (meth)acrylate monomer may include the bifunctional first (meth)acrylate monomer and the monofunctional second (meth)acrylate monomer in a weight ratio of 1:3 to 1:20, or a weight ratio of 1:5 to 1:16.

If the (meth)acrylate monomer includes the second (meth)acrylate monomer in a small amount compared to the above-described range with respect to the first (meth)acrylate monomer, the adhesion between an ink layer and an adhesive layer is reduced, which may result in insufficient adhesion of an interior film. In addition, if the (meth)acrylate monomer includes the second (meth)acrylate monomer in an excessive amount compared to the above-described range with respect to the first (meth)acrylate monomer, the adhesion between a digital printed coating film and a base layer is degraded, which may cause a problem of insufficient adhesion of an interior film.

In addition, the (meth)acrylate monomer may include the second-1 (meth)acrylate monomer and the second-2 (meth) acrylate monomer in a weight ratio of 1:0.8 to 1:2, or a weight ratio of 1:1 to 1:1.6.

In addition, the (meth)acrylate monomer may be included in an amount of 38 wt % to 65 wt %, or 42 wt % to 58 wt % based on the total weight of the ink composition. If the content of the (meth)acrylate monomer is less than the above-described range, due to an increase in the content of an oligomer, the ink composition has increased viscosity, which may degrade output stability during digital output, and if greater than the above-described range, the content of an oligomer decreases, which may degrade adhesion.

Specifically, the ink composition may include 3 wt % to 10 wt %, 3 wt % to 9 wt %, or 3 wt % to 8 wt % of the first (meth)acrylate monomer, and 35 wt % to 55 wt %, or 39 wt % to 50 wt % of the second (meth)acrylate-based monomer, based on the total weight of the ink composition. If the content of the first (meth)acrylate monomer is less than the above-described range, the adhesion of an ink coating surface to a base layer, which is a digital printed surface, may be degraded, and if greater than the above-described range, the hardness of the ink coating surface increases, which may generate cracks (ink layer breakage) in an embossing process when manufacturing an interior film. In addition, if the content of the second (meth)acrylate monomer is less than the above-described range, the adhesion between an ink layer and a coating surface of an adhesive layer may be degraded, and if greater than the above-described range, the adhesion between a base layer, which is a digital printed surface, and an ink coating surface may be degraded.

More specifically, the ink composition may include 3 wt % to 10 wt %, 3 wt % to 9 wt %, or 3 wt % to 8 wt % of the first (meth)acrylate monomer, 15 wt % to 25 wt %, 15 wt % to 24 wt %, or 17 wt % to 23 wt % of the second-1 (meth)acrylate monomer, and 20 wt % to 30 wt %, 21 wt % to 28 wt %, or 22 wt % to 27 wt % of the second-2 (meth)acrylate monomer, based on the total weight of the ink composition. If the content of the first (meth)acrylate monomer is less than the above-described range, the adhesion between a base layer, which is a digital printed surface, and a printed coating surface is degraded, which may degrade the adhesion of an interior film, and if greater than the above-described range, cracks (coating surface breakage phenomenon) may be generated in an embossing process when manufacturing an interior film, which may degrade the quality of a digital printed image. In addition, if the content of the second-1 (meth)acrylate monomer is less than the above-described range, the adhesion between a digital printed surface and an adhesive layer is insufficient, which may degrade the adhesion of an interior film, and if greater than the above-described range, the adhesion between a base layer, which is a digital printed surface, and a printed coating surface is degraded, which may degrade the adhesion of an interior film. Furthermore, if the content of the second-2 (meth)acrylate monomer is less than the above-described range, the ultraviolet initiator may have degraded solubility during ink manufacturing, and as time elapses after the ink manufacturing, the ultraviolet initiator is recrystallized, which may cause a problem in that a nozzle of a digital printer head is clogged. Meanwhile, if out of the above-described range, the ink composition may have reduced viscosity, or may have degraded adhesion due to a change in the content of the oligomer.

### Caprolactam-Based Compound

A caprolactam-based compound serves to improve adhesion to a base layer when preparing an ink layer by using an ink composition, and to improve heat resistance of the prepared ink layer.

The caprolactam-based compound may have a weight average molecular weight of 50 g/mol to 500 g/mol, 80 g/mol to 400 g/mol, or 100 g/mol to 300 g/mol. If the weight average molecular weight of the caprolactam-based compound is less than the above-described range, the adhesion and heat resistance of the ink composition may be degraded, and if greater than the above-described range, the color of an ink may change or the storage stability of the ink may be degraded.

In addition, the caprolactam-based compound may be, for example, n-vinylcaprolactam.

The caprolactam-based compound may be included in an amount of 10 wt % to 20 wt %, or 12 wt % to 18 wt % based on the total weight of the ink composition. If the content of the caprolactam-based compound is less than the above-described range, the ink composition may have degraded adhesion, and has weak heat resistance, which may cause a problem in that the color of an ink layer changes during an interior film lamination process, and if greater than the above-described range, the dispersion stability of a pigment in an ink is degraded, so that the pigment clumps over time, thereby increasing a particle size, or the pigment is precipitated, which may cause a problem with the storage stability of an ink.

### UV Initiator

An ultraviolet initiator absorbs ultraviolet rays, thereby initiating polymerization to cure an ink composition, and thus serves to form a coating film and to control the curing rate of the ink composition.

The ultraviolet initiator may include a first phosphine oxide-based compound containing one acyl group, and a second phosphine oxide-based compound containing two or more acyl groups.

The first phosphine oxide-based compound absorbs ultraviolet rays, thereby initiating polymerization to cure an ink composition, and thus serves to form a coating film and to control the curing rate of the ink composition.

In addition, the first phosphine oxide-based compound may be, for example, a diphenyl(2,4,6-trimethylbenzoyl)phosphine oxide (TPO).

The second phosphine oxide-based compound absorbs ultraviolet rays, thereby initiating polymerization to control the curing rate of the ink composition and to control a final degree of curing of a prepared ink layer.

In addition, the second phosphine oxide-based compound may be, for example, a phenylbis(2,4,6-trimethylbenzoyl)phosphine oxide (BAPO).

The ultraviolet initiator may be included in an amount of 4 wt % to 12 wt %, or 6 wt % to 10 wt % based on the total weight of the ink composition. If the content of the ultraviolet initiator is less than the above-described range, the ink composition may not be cured, and if greater than the above-described range, the ultraviolet initiator may not be sufficiently dissolved, and a change in ink curing performance with respect to the content of the ultraviolet initiator is insignificant, which is not preferable in terms of economic feasibility.

Specifically, the ink composition may include 3 wt % to 7 wt %, or 4 wt % to 6 wt % of the first phosphine oxide-based compound, and 1 wt % to 5 wt %, or 2 wt % to 4 wt % of the second phosphine oxide-based compound, based on the total weight of the ink composition. If the content of the first phosphine oxide-based compound is less than the above-described range, the ink composition may not be cured, and if greater than the above-described range, the ultraviolet initiator may not be dissolved due to the introduction of an excessive amount of the ultraviolet initiator, and the degree of improvement in ink curing performance with respect to the amount of the ultraviolet initiator used is insufficient, which may reduce economic feasibility. In addition, if the content of the second phosphine oxide-based compound is out of the above-described range, the ultraviolet initiator may not be dissolved due to the introduction of an excessive amount of the ultraviolet initiator, and the degree of improvement in ink curing performance with respect to the amount of the ultraviolet initiator used is insufficient, which may reduce economic feasibility, and as the ultraviolet initiator is recrystallized due to a change in time or temperature of an ink, which may cause a problem in that a nozzle of a digital printer is clogged.

Meanwhile, if only the first phosphine oxide-based compound is used without using the second phosphine oxide-based compound, the ink composition is not curing during curing after digital printing output, which may degrade peel strength or cause of problem of blocking when mounting a printed material.

### Additive

The ultraviolet-curable ink composition may further include an additive such as a surface tension modifier, a surfactant, a preservative, and the like, and may also include an additive commonly applicable to an ink.

As an example, the surface tension modifier serves to control the wetting of an ink composition to a base layer, thereby improving surface tension of the ink composition. Specifically, the surface tension modifier may be polyether-modified polydimethylsiloxane. In addition, the surface tension modifier may be included in an amount of 0.001 wt % to 0.3 wt % based on the total weight of the ink composition. If the content of the surface tension modifier is out of the above-described range, the ink composition has insufficient surface tension, which may cause an output defect problem of the ink composition.

The ultraviolet-curable ink composition may have a viscosity at 25° C. of 15 cps to 23 cps. If the viscosity 25° C. of the ultraviolet-curable ink composition is less than the above-described range, when an ink is discharged from an inkjet printer head, the ink may be scattered, thereby leaving a large number of satellites on a printed material, and if greater than the above-described range, an ink may not be discharged from a nozzle in the form of a microtube during printing, which may cause the nozzle to be displaced.

In addition, the ultraviolet-curable ink composition may have an average particle size of dispersed particles of 50 nm to 200 nm, or 100 nm to 150 nm. If the average particle size of the dispersed particles in the ultraviolet-curable ink composition is in the above-described range, stable head discharge properties may be exhibited as an inkjet ink. On the other hand, if the average particle size of the dispersed particles in the ultraviolet-curable ink composition is out of the above-described range, a head may be clogged during printing or the shielding force (color density) of a printed material may be degraded, which may cause a problem in that the ink composition has reduced color development, and a nozzle is clogged.

The ultraviolet-curable ink composition may have a glass transition temperature (Tg) of −70° C. to −30° C., or −60° C. to −40° C. If the glass transition temperature of the ultraviolet-curable ink composition is in the above-described range, there is an effect in that ink curing performance is excellent and output stability during digital printing is excellent. On the other hand, if the glass transition temperature of the ultraviolet-curable ink composition is less than the above-described range, ink curing performance may be insufficient, and output stability may be degraded during digital printing, and if greater than the above-described range, output stability may be degraded during digital printing, or there may be a problem with ink fluidity in a printer.

The ultraviolet-curable ink composition according to the present invention as described above has excellent storage stability at room temperature (25° C.) and a high temperature (60° C.), has excellent image resolution after printing, enables interlayer lamination with a base material such as PVC, and has excellent design freedom and printability during printing.

### Interior Film

In addition, an interior film according to the present invention includes a base layer, an ink layer formed on the base layer, and formed from the ultraviolet-curable ink composition, an adhesive layer formed on the ink layer, and a transparent protective layer formed on the adhesive layer.

### Base Layer

The base layer may be used without any particular limitation as long as it is typically applicable to an interior film or a decorative film, and may include, for example, a vinyl chloride-based resin.

The vinyl chloride-based resin may be one or more selected from the group consisting of polyvinyl chloride (PVC), polyvinylidene chloride (PVDC), and vinyl chloride, and a vinyl chloride-based copolymer containing a monomer copolymerized therewith.

The base layer may use a commercially available product typically applicable to an interior film or a decorative film, and may have, for example, an average thickness of 30 μm to 200 μm, or 50 μm to 150 μm.

### Ink Layer

The ink layer is formed from the ultraviolet-curable ink composition as described above.

The ink layer may be formed by a digital printing method sing the ultraviolet-curable ink composition. For example, the ink layer may be formed by printing an ultraviolet-curable ink composition on a base layer by a digital printing method.

### Adhesive Layer

The adhesive layer is formed on the ink layer to bond the ink layer and the transparent protective layer.

The adhesive layer may be used without any particular limitation as long as it is typically applicable to an interior film or a decorative film, and may include, for example, an ultraviolet-curable adhesive. Specifically, the adhesive layer may include an oligomer, a monomer, an ultraviolet initiator, and the like.

In addition, the adhesive layer may be applied to a thickness typically applicable to an interior film or a decorative film, and may have, for example, an average thickness of 1 μm to 20 μm, or 2 μm to 10 μm.

### Transparent Protective Layer

The protective layer may be used without any particular limitation as long as it is typically applicable to an interior film or a decorative film, and may include, for example, a vinyl chloride-based resin.

The vinyl chloride-based resin may be one or more selected from the group consisting of polyvinyl chloride (PVC), polyvinylidene chloride (PVDC), and vinyl chloride, and a vinyl chloride-based copolymer containing a monomer copolymerized therewith.

The transparent protective layer may be formed by a method typically applicable to an interior film or a decorative film, and may be formed by, for example, a method of performing lamination on the adhesive layer and then performing curing by irradiation with ultraviolet rays.

In addition, the transparent protective layer may use a commercially available product typically applicable to an interior film or a decorative film, and may have, for example, an average thickness of 50 μm to 200 μm, or 80 μm to 130 μm. If the average thickness of the transparent protective layer is out of the above-described range, an effect of deep embossing is not implemented, resulting in poor texture, or the film price increases due to a thick thickness, which may reduce economic feasibility.

The interior film according to the present invention as described above has excellent image resolution of an ink layer, and has excellent interlayer adhesion, so that the physical properties and productivity of a product are excellent.

Hereinafter, the present invention will be described in more detail with reference to examples.

### MODE FOR CARRYING OUT THE INVENTION

### Examples

### Experimental Examples 1 to 21. Preparation of Ultraviolet-Curable Ink Composition

A UV-curable ink composition was prepared by adjusting the composition as described in Tables 1 to 4.

TABLE 1

| | Experimental | Experimental | Experimental | Experimental | Experimental |
|---|---|---|---|---|---|
| Component (wt %) | Example 1 | Example 2 | Example 3 | Example 4 | Example 5 |
| Pigment dispersion | 20.00 | 20.00 | 20.00 | 20.00 | 20.00 |
| Oligomer 1 | 5.00 | 8.00 | 10.00 | | 8.00 |
| Oligomer 2 | | | | 5.00 | |
| Oligomer 3 | | | | | |
| Oligomer 4 | | | | | |
| Oligomer 5 | | | | | |
| Monomer 1 | 5.00 | 5.00 | 5.00 | 5.00 | 3.00 |
| Monomer 2 | 20.00 | 20.00 | 20.00 | 20.00 | 23.00 |
| Monomer 3 | 23.99 | 23.99 | 23.99 | 23.99 | 22.99 |
| Monomer 4 | | | | | |
| Monomer 5 | | | | | |
| Monomer 6 | | | | | |
| Caprolactam-based | 18.00 | 15.00 | 13.00 | 18.00 | 15.00 |
| compound | | | | | |
| UV initiator 1 | 5.00 | 5.00 | 5.00 | 5.00 | 5.00 |
| UV initiator 2 | 3.00 | 3.00 | 3.00 | 3.00 | 3.00 |
| Surface tension | 0.01 | 0.01 | 0.01 | 0.01 | 0.01 |
| modifier | | | | | |
| Total sum | 100 | 100 | 100 | 100 | 100 |

TABLE 2

| | Experimental | Experimental | Experimental | Experimental | Experimental |
|---|---|---|---|---|---|
| Component (wt %) | Example 6 | Example 7 | Example 8 | Example 9 | Example 10 |
| Pigment dispersion | 20.00 | 20.00 | 20.00 | 20.00 | 20.00 |
| Oligomer 1 | 8.00 | 8.00 | 13.00 | 3.00 | |
| Oligomer 2 | | | | | |
| Oligomer 3 | | | | | 5.00 |
| Oligomer 4 | | | | | |
| Oligomer 5 | | | | | |
| Monomer 1 | 8.00 | 5.00 | 5.00 | 5.00 | 5.00 |
| Monomer 2 | 17.00 | 17.00 | 20.00 | 20.00 | 20.00 |
| Monomer 3 | 23.99 | 26.99 | 23.99 | 23.99 | 23.99 |
| Monomer 4 | | | | | |
| Monomer 5 | | | | | |
| Monomer 6 | | | | | |
| Caprolactam-based | 15.00 | 15.00 | 10.00 | 20.00 | 18.00 |
| compound | | | | | |
| UV initiator 1 | 5.00 | 5.00 | 5.00 | 5.00 | 5.00 |
| UV initiator 2 | 3.00 | 3.00 | 3.00 | 3.00 | 3.00 |
| Surface tension | 0.01 | 0.01 | 0.01 | 0.01 | 0.01 |
| modifier | | | | | |
| Total sum | 100 | 100 | 100 | 100 | 100 |

TABLE 3

| | Experimental | Experimental | Experimental | Experimental | Experimental |
|---|---|---|---|---|---|
| Component (wt %) | Example 11 | Example 12 | Example 13 | Example 14 | Example 15 |
| Pigment dispersion | 20.00 | 20.00 | 20.00 | 20.00 | 20.00 |
| Oligomer 1 | | | 5.00 | 5.00 | 5.00 |
| Oligomer 2 | | | | | |
| Oligomer 3 | | | | | |
| Oligomer 4 | 5.00 | | | | |
| Oligomer 5 | | 5.00 | | | |
| Monomer 1 | 5.00 | 5.00 | 5.00 | | |
| Monomer 2 | 20.00 | 20.00 | | 5.00 | 20.00 |
| Monomer 3 | 23.99 | 23.99 | | 20.00 | 23.99 |
| Monomer 4 | | | 43.99 | | |
| Monomer 5 | | | | 23.99 | |
| Monomer 6 | | | | | 5.00 |
| Caprolactam-based | 18.00 | 18.00 | 18.00 | 18.00 | 18.00 |
| compound | | | | | |
| UV initiator 1 | 5.00 | 5.00 | 5.00 | 5.00 | 5.00 |
| UV initiator 2 | 3.00 | 3.00 | 3.00 | 3.00 | 3.00 |
| Surface tension | 0.01 | 0.01 | 0.01 | 0.01 | 0.01 |
| modifier | | | | | |
| Total sum | 100 | 100 | 100 | 100 | 100 |

TABLE 4

| Component | Experimental | Experimental | Experimental | Experimental | Experimental | Experimental |
|---|---|---|---|---|---|---|
| (wt %) | Example 16 | Example 17 | Example 18 | Example 19 | Example 20 | Example 21 |
| Pigment | 20.00 | 20.00 | 20.00 | 20.00 | 20.00 | 20.00 |
| dispersion | | | | | | |
| Oligomer 1 | 5.00 | 1.00 | 16.00 | | 23.00 | 5.00 |
| Oligomer 2 | | | | | | |
| Oligomer 3 | | | | | | |
| Oligomer 4 | | | | | | |
| Oligomer 5 | | | | | | |
| Monomer 1 | | | | 2.00 | 5.00 | 20.00 |
| Monomer 2 | 38.99 | 25.00 | 25.00 | 51.99 | 20.00 | 20.00 |
| Monomer 3 | | 23.99 | 23.99 | | 23.99 | 23.00 |
| Monomer 4 | | | | | | |
| Monomer 5 | 5.00 | | | | | |
| Monomer 6 | 5.00 | | | | | |
| Caprolactam- | 18.00 | 22.00 | 7.00 | 18.00 | | 7.00 |
| based compound | | | | | | |
| UV initiator 1 | 5.00 | 5.00 | 5.00 | 5.00 | 5.00 | 5.00 |
| UV initiator 2 | 3.00 | 3.00 | 3.00 | 3.00 | 3.00 | |
| Surface tension | 0.01 | 0.01 | 0.01 | 0.01 | 0.01 | |
| modifier | | | | | | |
| Total sum | 100 | 100 | 100 | 100 | 100 | 100 |

The manufacturer, product name, and other properties of each component used in Experimental Examples above are shown in Table 5 below. In addition, Mw refers to a weight average molecular weight, and the average particle size of dispersed particles is a value measured by the same method as in Item (1) of Test Example below.

TABLE 5

| Component | Notes |
|---|---|
| Pigment | Manufacturer: InkTec Co., Ltd. Product name: CIB-N(PB 15:4 |
| dispersion | Dispersion:Pigment concentration 15 wt %, Average particle size: |
| | 120 nm, Viscosity (25° C.): 28 cps) |
| Oligomer 1 | Bifunctional urethane acrylate oligomer (Mw 1,000 g/mol, |
| | viscosity (25° C.) 3,550 cps) |
| Oligomer 2 | Bifunctional urethane acrylate oligomer (Mw 1,500 g/mol, |
| | viscosity (25° C.) 4,470 cps) |
| Oligomer 3 | Monofunctional urethane acrylate oligomer (Mw 440 g/mol, |
| | viscosity (25° C.) 910 cps) |
| Oligomer 4 | Bifunctional urethane acrylate oligomer (Mw 3,700 g/mol, |
| | viscosity (25° C.) 7,630 cps) |
| Oligomer 5 | Trifunctional epoxy acrylate oligomer (Mw 1,800 g/mol, viscosity |
| | (25° C.) 4,830 cps) |
| Monomer 1 | Bifunctional monomer (1,6-hexanediol diacrylate, HDDA) |
| Monomer 2 | Monofunctional monomer (tetrahydrofurfuryl methacrylate, |
| | THFA) |
| Monomer 3 | Monofunctional monomer (phenoxyethyl acrylate, PHEA) |
| Monomer 4 | Trifunctional monomer (trimethylolpropane triacrylate, TMPTA) |
| Monomer 5 | Trifunctional monomer (ethoxylated trimethylolpropane |
| | triacrylate, ETPTA) |
| Monomer 6 | Tetrafunctional monomer (Pentaerythritol tetraacrylate, PETA) |
| Caprolactam- | N-vinylcaprolactam (NVC) |
| based compound | |
| UV initiator 1 | Diphenyl(2,4,6-trimethylbenzoyl)phosphine oxide |
| UV initiator 2 | Phenylbis(2,4,6-trimethylbenzoyl)phosphine oxide |
| Surface tension | Polyether modified polydimethylsiloxane (Manufacturer: BYK, |
| modifier | Product name: BYK-UV3510) |

### Test Example: Evaluation of Properties

Physical properties of a ultraviolet-curable ink composition of Test Example were measured by the following methods, and the results are shown in Table 6.

### (1) Average Particle Size of Particles Dispersed in Composition

Distribution of particle sizes of particles dispersed in the composition was measured by laser light scattering (LLS), and then an average value of particle diameters of 10% (D₁₀) to 90% (D₉₀) of cumulative distribution in the distribution of particle sizes was set as an average particle size.

### (2) Viscosity of at 25° C.

It was measured at room temperature (25° C.) by using a viscometer (Brookfield spindle viscometer, Brookfield Viscometer LVDV-II, CPE-40 spindle).

### (3) Storage Stability

The ultraviolet-curable ink composition was stored at 25° C. or 60° C. for 2 weeks, and then dispersed particles were measured for an average particle size, and a viscosity at 25° C. or 60° C. in the same manner as in Items (1) and (2) above, and storage stability was evaluated based on the following criteria.

Specifically, it was evaluated as good if an amount of change was 10% compared to the initial measured values, and as defective if an amount of change was greater than 10%.

### (4) Output Properties

Using the ink composition of each Experimental Example, output properties were evaluated by checking the number of cases in which the nozzle of a head corresponding to a monochromatic unit was displaced while performing output continuously for 1 hour using a 1024i series of KONNIKA Corporation and a digital printing device equipped with a RICHO GEN5 head. It was evaluated as good if the number of cases in which the nozzle was displaced was 3 or fewer.

### (5) Peel Strength

Using the same device as the digital printing device used in Item (4), the ink composition of Experimental Example was printed in a single color on a colored PVC base film (manufacturer: Geumgang Enterprise, product name: KKP PRINT, thickness: 80 μm) to form an ink layer. Thereafter, a UV adhesive (manufacturer: Permabond, product name: Permabond UV640) was applied to 7 μm to 8 μm on the ink layer, covered by a PVC transparent film (manufacturer: Geumgang Enterprise, product name: KKP DECO, thickness: 110 μm), and irradiated with ultraviolet rays by using an LED light source having a wavelength of 395 nm to prepare a specimen. In this case, by using a product having an adhesive force of 5 kgf/inch or greater as the UV adhesive, a portion separated when measuring the peel strength was set as an ink layer, and a measured strength was also set as a measured strength of the ink layer.

The lamination order was in the order of the colored PVC film, the ink layer, the adhesive layer, and the PVC transparent film. Thereafter, the prepared specimen was measured for 180° peel strength between the ink layer and the PVC transparent film by using a tensile tester (Universal Testing Machine, manufacturer: SALT, model name: ST-1003).

### (6) Generation of Cracks

A specimen was prepared as in the same manner as in Item (5), and then the specimen was passed through a roll made of SUS and having a depth of 200 μm at 170° C. under a pressure of 6 MPa to create an embossing texture. Thereafter, it was visually confirmed whether a printed surface was intact in a portion pressed to a depth of 200 μm.

TABLE 6

| | | | Storage stability at | | | Storage stability at | | | | | |
|---|---|---|---|---|---|---|---|---|---|---|---|
| | | | 25° C. | | | 60° C. | | | | | |
| | Average | | Average | | | Average | | | | | |
| | particle | Viscosity | particle | | | particle | | | | Generation | Peel |
| | size | (25° C.) | size | Viscosity | | size | Viscosity | | Output | of | strength |
| | (nm) | (cps) | (nm) | (cps) | Evaluation | (nm) | (cps) | Evaluation | properties | cracks | (kgf/inch) |
| Experimental | 123 | 18.0 | 124 | 17.6 | Good | 121 | 17.5 | Good | 0 | X | 3.1 |
| Example 1 | | | | | | | | | | | |
| Experimental | 127 | 19.6 | 125 | 19.4 | Good | 122 | 19.3 | Good | 0 | X | 3.5 |
| Example 2 | | | | | | | | | | | |
| Experimental | 129 | 22.1 | 126 | 22.0 | Good | 120 | 21.5 | Good | 0 | X | 3.6 |
| Example 3 | | | | | | | | | | | |
| Experimental | 121 | 17.5 | 123 | 17.1 | Good | 124 | 17.00 | Good | 1 | X | 3.2 |
| Example 4 | | | | | | | | | | | |
| Experimental | 123 | 18.6 | 121 | 18.2 | Good | 123 | 18.0 | Good | 0 | X | 3.0 |
| Example 5 | | | | | | | | | | | |
| Experimental | 125 | 19.9 | 129 | 19.4 | Good | 121 | 19.0 | Good | 0 | X | 3.4 |
| Example 6 | | | | | | | | | | | |
| Experimental | 127 | 19.2 | 124 | 18.9 | Good | 128 | 18.7 | Good | 0 | X | 3.3 |
| Example 7 | | | | | | | | | | | |
| Experimental | 126 | 22.8 | 124 | 22.5 | Good | 125 | 22 | Good | 3 | X | 3.1 |
| Example 8 | | | | | | | | | | | |
| Experimental | 122 | 16.1 | 123 | 15.5 | Good | 124 | 15.1 | Good | 2 | X | 3.4 |
| Example 9 | | | | | | | | | | | |
| Experimental | 124 | 14.2 | 123 | 14.0 | Good | 122 | 13.9 | Good | 3 | X | 0.9 |
| Example 10 | | | | | | | | | | | |
| Experimental | 123 | 25.0 | 121 | 24.3 | Good | 123 | 24.1 | Good | 13 | X | 3.2 |
| Example 11 | | | | | | | | | | | |
| Experimental | 121 | 20.1 | 125 | 19.6 | Good | 121 | 19.8 | Good | 1 | ◯ | 1.2 |
| Example 12 | | | | | | | | | | | |
| Experimental | 123 | 26.1 | 122 | 25.6 | Good | 122 | 25.7 | Good | 24 | ◯ | 3.1 |
| Example 13 | | | | | | | | | | | |
| Experimental | 125 | 21.6 | 124 | 20.4 | Good | 123 | 20.6 | Good | 12 | ◯ | 3.2 |
| Example 14 | | | | | | | | | | | |
| Experimental | 123 | 19.7 | 124 | 19.5 | Good | 120 | 19.40 | Good | 1 | ◯ | 3.0 |
| Example 15 | | | | | | | | | | | |
| Experimental | 126 | 22.3 | 125 | 21.9 | Good | 127 | 21.50 | Good | 1 | ◯ | 3.3 |
| Example 16 | | | | | | | | | | | |
| Experimental | 122 | 16.1 | 142 | 17.3 | Poor | 158 | 18.30 | Poor | 2 | X | 0.4 |
| Example 17 | | | | | | | | | | | |
| Experimental | 124 | 23.0 | 121 | 22.9 | Good | 126 | 22.5 | Good | 10 | X | 3.6 |
| Example 18 | | | | | | | | | | | |
| Experimental | 124 | 13.4 | 121 | 13.0 | Good | 123 | 13.10 | Good | 2 | X | 0.7 |
| Example 19 | | | | | | | | | | | |
| Experimental | 124 | 27.0 | 126 | 26.5 | Good | 125 | 26.10 | Good | 16 | X | 3.7 |
| Example 20 | | | | | | | | | | | |
| Experimental | 120 | 16.5 | 122 | 16.2 | Good | 120 | 16.00 | Good | 1 | ◯ | 2.7 |
| Example 21 | | | | | | | | | | | |

As shown in Table 6 above, the compositions of Experimental Examples 1 to 9 had a suitable average particle size of the dispersed particles, suitable viscosity at 25° C., and excellent storage stability and output properties, and the prepared ink layer also had excellent peel strength without having cracks.

On the other hand, Experimental Example 10 including Oligomer 3 including a monofunctional urethane acrylate oligomer, and Experimental Example 19 not including a urethane acrylate oligomer had low viscosity at 25° C., and thus had insufficient ink discharge properties, and the prepared ink layer also had insufficient peel strength.

In addition, Experimental Example 11 including Oligomer 4 having high viscosity at 25° C. and a high weight average molecular weight, Experimental Examples 13 and 14 including Monomer 4 or Monomer 5, which is a trifunctional acrylate monomer, and Experimental Example 20 including an excessive amount of a urethane acrylate oligomer had high viscosity at 25° C. and/or insufficient ink discharge properties, and insufficient output properties. Particularly, Experimental Examples 13 and 14 had cracks in the prepared ink layer.

Experimental Example 12 including Oligomer 5 including a trifunctional epoxy acrylate oligomer, and Experimental Example 21 using a small amount of a caprolactam-based compound and not including a surface tension modifier had cracks in the prepared ink layer, and the peel strength thereof was also insufficient.

Experimental Example 15 including Monomer 6, which is a tetrafunctional acrylate monomer, and Experimental Example 16 including Monomer 5, which is a trifunctional acrylate monomer, and Monomer 6, which is a tetrafunctional monomer, had cracks in the prepared ink layer.

In addition, Experimental Example 17 including a small amount of a urethane acrylate oligomer and not including a bifunctional first acrylate monomer had insufficient storage stability at room temperature (25° C.) and a high temperature (60° C.), so that there was a significant change in the viscosity, and the prepare ink layer also had insufficient peel strength.

Experimental example 18 including an excessive amount of a urethane acrylate oligomer and not including a bifunctional first acrylate monomer had insufficient output properties of the ink composition, so that a nozzle was displaced during printing.

1. An ultraviolet-curable ink composition comprising:
a pigment; a urethane(meth)acrylate oligomer; a (meth)acrylate monomer; a caprolactam-based compound; and an ultraviolet initiator,
wherein the urethane(meth)acrylate oligomer includes two functional groups, and has a weight average molecular weight of 500 g/mol to 2,000 g/mol.

2. The ultraviolet-curable ink composition of claim 1, wherein:
the urethane(meth)acrylate oligomer has a viscosity at 25° C. of 1,000 cps to 5,000 cps; and
the (meth)acrylate monomer has a weight average molecular weight of 100 g/mol to 1,000 g/mol.

3. The ultraviolet-curable ink composition of claim 1, wherein the (meth)acrylate monomer comprises a bifunctional first (meth)acrylate monomer, and a monofunctional second (meth)acrylate monomer,
wherein the (meth)acrylate monomer comprises the bifunctional first (meth)acrylate monomer and the monofunctional second (meth)acrylate monomer in a weight ratio of 1:3 to 1:20.

4. The ultraviolet-curable ink composition of claim 1, wherein the ultraviolet initiator comprises a first phosphine oxide-based compound containing one acyl group, and a second phosphine oxide-based compound containing two or more acyl groups.

5. The ultraviolet-curable ink composition of claim 1, wherein the ultraviolet-curable ink composition comprises 13 wt % to 24 wt % of the pigment, 3 wt % to 15 wt % of the urethane(meth)acrylate oligomer, 38 wt % to 65 wt % of the (meth)acrylate monomer, 10 wt % to 20 wt % of the caprolactam-based compound, and 4 wt % to 12 wt % of the ultraviolet initiator.

6. An interior film comprising:
a base layer;
an ink layer formed on the base layer, and formed from the ultraviolet-curable ink composition of claim 1;
an adhesive layer formed on the ink layer; and
a transparent protective layer formed on the adhesive layer.
